(19) United States
(12) Patent Application Publication
(10) Pub. No.: US 2013/0262966 A1
(43) Pub. Date: Oct. 3, 2013

(54) DIGITAL CONTENT REORDERING METHOD AND DIGITAL CONTENT AGGREGATOR

(71) Applicants: Shin-Yi Wu, Taipei City (TW); Yu-Hsiang Hsiao, New Taipei City (TW); Chi-Chun Kao, Taipei City (TW); Po-Yuan Ting, Taipei City (TW); Yi-Cyuan Chen, Kaohsiung City (TW); Wen-Hsi Yeh, Hsinchu County (TW)

(72) Inventors: Shin-Yi Wu, Taipei City (TW); Yu-Hsiang Hsiao, New Taipei City (TW); Chi-Chun Kao, Taipei City (TW); Po-Yuan Ting, Taipei City (TW); Yi-Cyuan Chen, Kaohsiung City (TW); Wen-Hsi Yeh, Hsinchu County (TW)

(73) Assignee: INDUSTRIAL TECHNOLOGY RESEARCH INSTITUTE, Hsinchu (TW)

(21) Appl. No.: 13/488,460

(22) Filed: Jun. 5, 2012

(30) Foreign Application Priority Data
Apr. 2, 2012 (TW) 101111679

(51) Int. Cl. G06F 17/00

(52) U.S. Cl. 715/202

(57) ABSTRACT

A digital content reordering method and a digital content aggregator are provided, in which a reading behavior log and/or a social behavior log of a user are analyzed to obtain a preference factor of the user regarding digital contents in at least one content stream. The digital content reordering method and the digital content aggregator aggregate the at least one content stream into an aggregated stream and determine the order of the digital contents in the aggregated stream according to a time factor of the digital contents and the preference factor of the user regarding the digital contents. This reordering process allows the user to view the latest, the most related, and the most interesting digital contents first.

### CROSS-REFERENCE TO RELATED APPLICATION

This application claims the priority benefit of Taiwan application serial no. 101111679, filed on Apr. 2, 2012. The entirety of the above-mentioned patent application is hereby incorporated by reference herein and made a part of this specification.

### BACKGROUND

1. Technical Field

The disclosure relates to a digital content reordering method and a digital content aggregator.

2. Background

Along with the widespread of the iPad, digital content aggregation software, such as Flipboard, has been developed. Flipboard is an application specifically designed for the iPad, and which allows a user to subscribe to different content sources, wherein each of the content sources provides many digital contents. If a content source is an e-magazine, the digital contents thereof are articles in the magazine. If a content source is a social network, such as the Facebook, the Twitter, or the Plurk, the digital contents thereof are sentences, articles, images, and videos posted by its users. These digital contents are continuously generated or posted with time therefore can be referred to as a content stream. In the Flipboard, each subscribed content source is considered a virtual magazine. For example, the Facebook and the Twitter are respectively a magazine. The magazine-format digital content presentation makes the Flipboard very popular. However, if too many content sources are subscribed, the problem of information overload may be caused.

A personalized resolution for resolving the problem of information overload is provided by another application Zite. A user of the Zite can set up a desired subject, such as cars, pets, or foods. In addition, the Zite can observe the reading behavior of a user and continuously understand the user's interests by observing the subjects clicked or not clicked by the user, the lengths of articles read by the user, and the reading duration of each article, so as to provide a personalized digital content presentation order.

### SUMMARY

The disclosure is directed to a digital content reordering method and a digital content aggregator, in which a reading behavior log and/or a social behavior log of a user are analyzed to obtain a preference factor of the user regarding digital contents in at least one content stream.

In the digital content reordering method and the digital content aggregator provided by the disclosure, the aforementioned content streams are aggregated into an aggregated stream, and the order of the aforementioned digital contents in the aggregated stream is determined according to a time factor of the digital contents and the preference factor of the user regarding the digital contents. Such a reordering process allows the user to read the latest, the most related, and the most interesting digital contents first, so that information overload caused by too many content sources is avoided.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a diagram of a digital content aggregator according to an embodiment of the disclosure.

FIG. 2 is a flowchart of a digital content reordering method according to an embodiment of the disclosure.

FIG. 3 is a diagram of a digital content aggregator according to an embodiment of the disclosure.

FIGS. 4A-4C are diagrams of a cluster tree according to an embodiment of the disclosure.

FIGS. 5A-6 are flowcharts of a digital content reordering method according to an embodiment of the disclosure.

FIG. 7 is a diagram of a digital content reordering method according to an embodiment of the disclosure.

### DETAILED DESCRIPTION OF DISCLOSED EMBODIMENTS

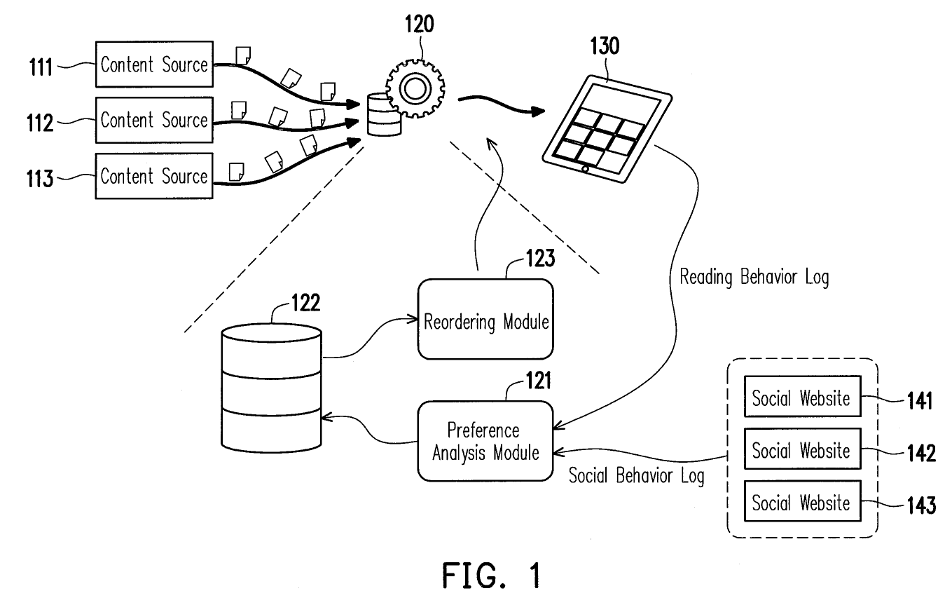

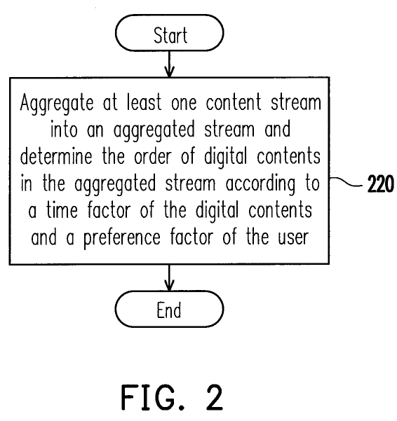

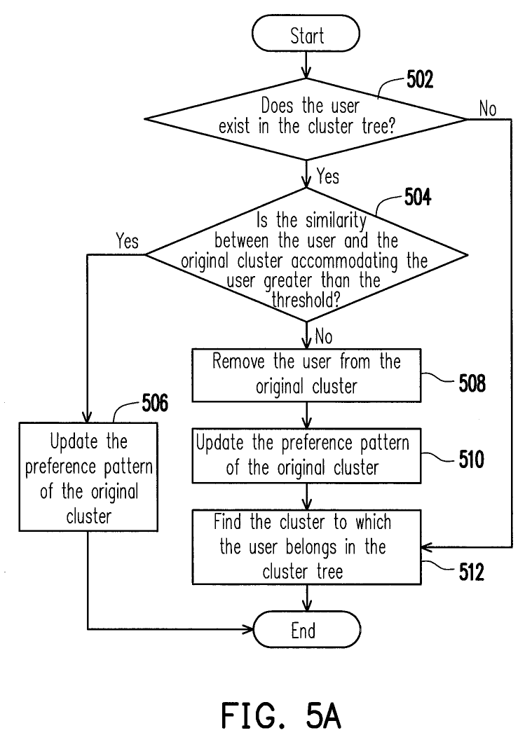

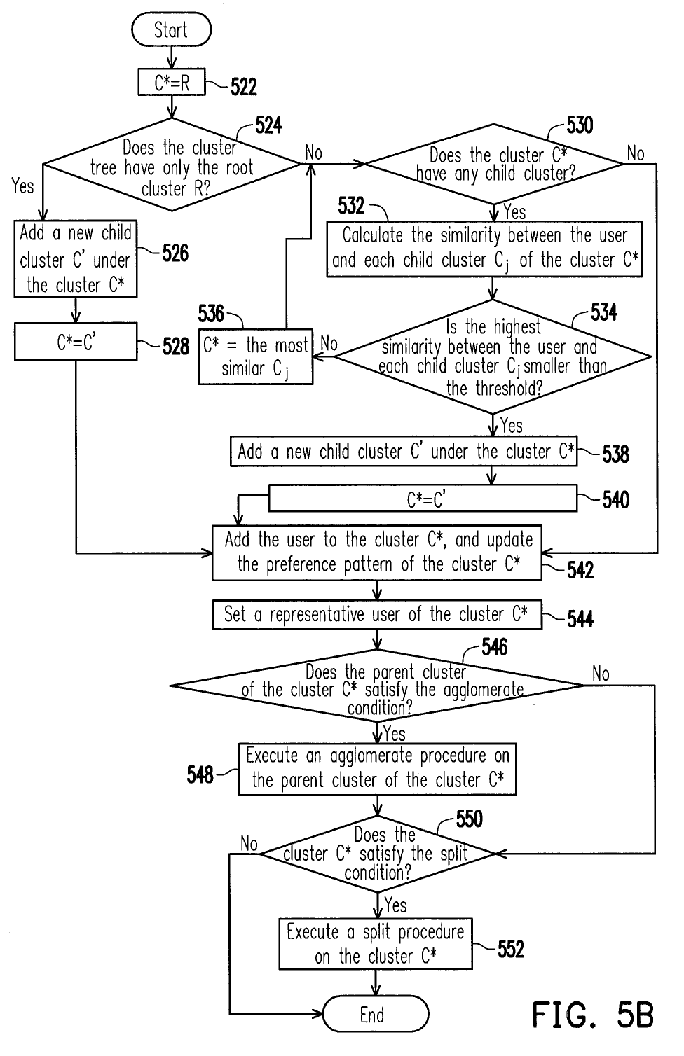

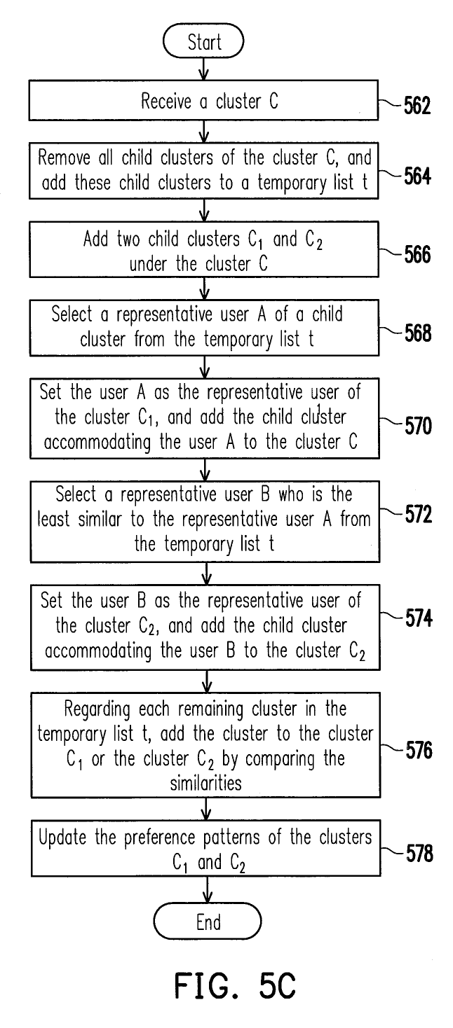

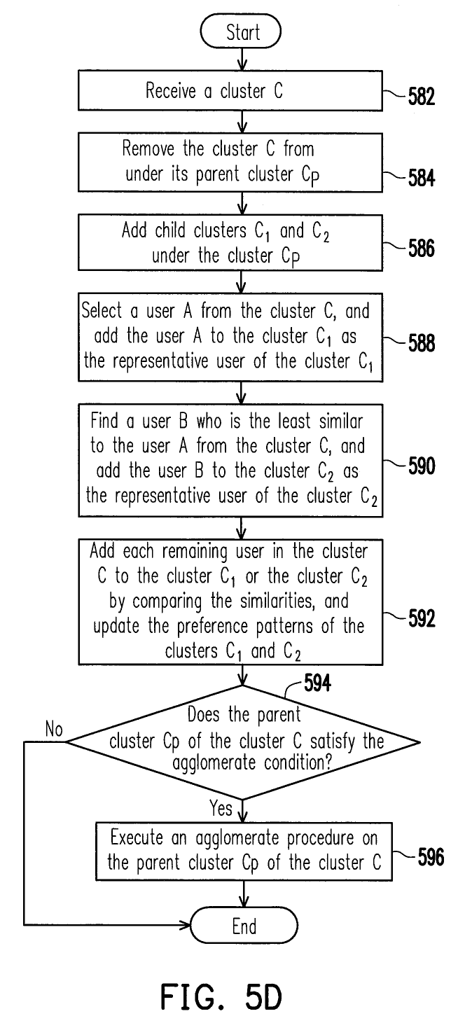

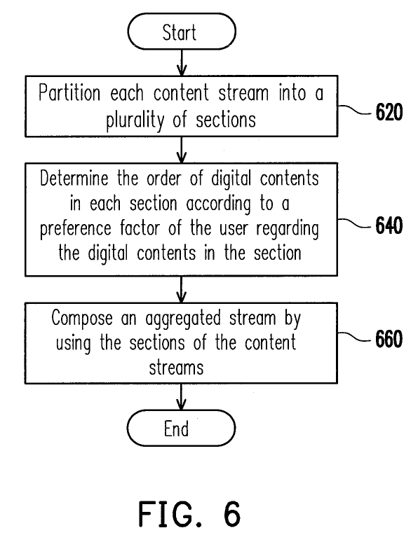

FIG. 1 is a diagram of a digital content aggregator 120 according to an embodiment of the disclosure. FIG. 2, FIGS. 5A-5D, and FIG. 6 are flowcharts of a digital content reordering method executed by the digital content aggregator 120, wherein FIG. 2 illustrates the main steps, and FIGS. 5A-5D and FIG. 6 illustrate the detailed steps.

In the present embodiment, one or more content sources (for example, content sources 111-113) provide one or more content streams to the digital content aggregator 120. The aforementioned content sources are digital content providers, such as social websites, news websites, or e-magazines. Referring to FIG. 2, in step 220, the digital content aggregator 120 aggregates aforementioned content streams into an aggregated stream and provides the aggregated stream to the viewer 130 to be displayed and viewed by a user. While aggregating the content streams, the digital content aggregator 120 determines the order of digital contents of the content streams in the aggregated stream according to a time factor of the digital contents and a preference factor of the user regarding the digital contents. The content streams are presented by the viewer 130 in aforementioned order. The time factor includes at least one of the publication date and the valid period of the digital contents. The preference factor includes at least one of the preferences and the social relation of the user regarding the digital contents.

The digital content aggregator 120 can provide the digital content aggregating and reordering service to multiple users. As in step 220, the digital content aggregator 120 aggregates the content streams subscribed by a specific user into an aggregated stream, reorders the digital contents in the aggregated stream, and provides the aggregated stream to a viewer of the user to be displayed. In order to allow the digital content aggregator 120 to analyze the preference of the user, the viewer records the reading behaviour of the user regarding the digital contents and provides a reading behavior log to the digital content aggregator 120. To analyze the social relation of a user, the digital content aggregator 120 obtains a social behavior log of the user from one or more social websites (for example, social websites 141-143) the user joins.

The digital content aggregator 120 includes a preference analysis module 121 and a reordering module 123. The preference analysis module 121 analyzes a preference factor of a user regarding the digital contents of the content streams according to the reading behavior log and/or the social behavior log of the user and stores the analysis result into a database 122. The preference analysis module 121 generates the analysis result in an incremental manner. Namely, the preference analysis module 121 analyzes the reading behavior log and/or the social behavior log generated during a latest predetermined period (for example, 90 days) and incrementally updates the analysis result according to variations of the reading behavior log and the social behavior log at predetermined intervals (for example, 5 minutes). The reordering module 123 aggregates the content streams into an aggregated stream and determines the order of the digital contents in the aggregated stream according to the time factor of the digital contents and the preference factor of the user. The reordering module 123 performs aforementioned aggregation and reordering operations on the content streams in real time. Namely, the reordering module 123 only performs the aggregation and reordering operations on the content streams when the viewer 130 is used for reading the digital contents.

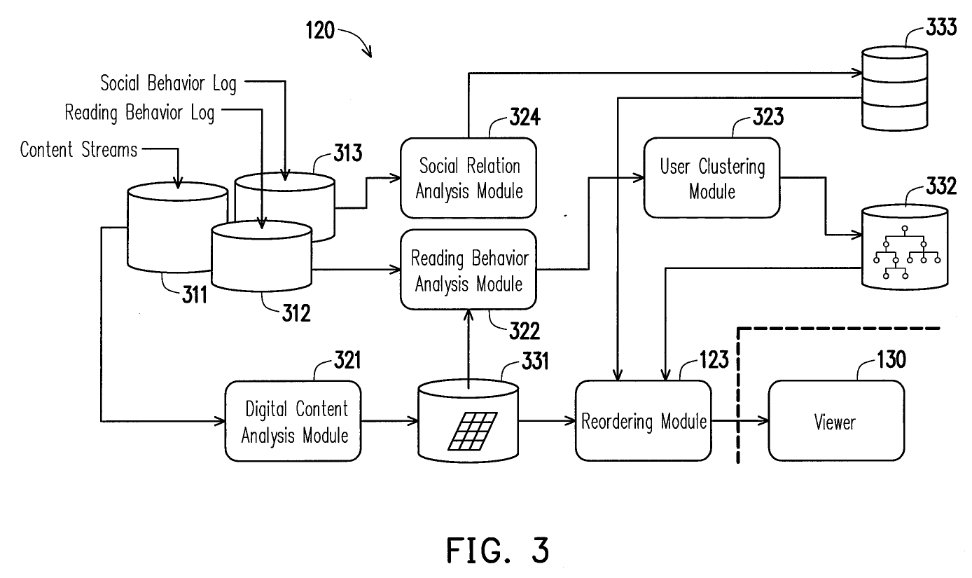

FIG. 3 is another diagram of the digital content aggregator 120. Referring to FIG. 3, the preference analysis module 121 includes a digital content analysis module 321, a reading behavior analysis module 322, a user clustering module 323, and a social relation analysis module 324. Databases 311-313 respectively store the content streams, the reading behavior log, and the social behavior log to be used by the digital content analysis module 321, the reading behavior analysis module 322, and the social relation analysis module 324. Referring to FIG. 3, the database 122 includes the databases 331-333, and the databases 331-333 respectively store data generated by the digital content analysis module 321, the user clustering module 323, and the social relation analysis module 324 to be used by the reordering module 123.

The databases 311-313 and 331-333 may be part or independent of the digital content aggregator 120. The disclosure is not limited to the adoption of databases, and in other embodiments, data stored in the databases 311-313 and 331-333 may also be stored in a storage device (for example, a hard disc or a memory) as files or other kinds of data structures. Herein the storage device may be independent of the modules illustrated in FIG. 3 or be part of one or more modules in FIG. 3.

The viewer 130 may be hardware or software. For example, the viewer 130 may be an electronic device that can be connected to a network, such as a smart phone, a tablet PC, a notebook computer, or a PC. Or the viewer 130 may also be an application program executed in aforementioned electronic devices. The digital content aggregator 120 may also be hardware or software, such as a server that can be connected to a network or software in the server. If the digital content aggregator 120 is hardware, the reordering module 123, the digital content analysis module 321, the reading behavior analysis module 322, the user clustering module 323, and the social relation analysis module 324 illustrated in FIG. 3 may be all hardware modules or software modules. If the digital content aggregator 120 is software, the reordering module 123, the digital content analysis module 321, the reading behavior analysis module 322, the user clustering module 323, and the social relation analysis module 324 illustrated in FIG. 3 are then software modules.

The digital content analysis module 321 analyzes and captures publication dates, lengths, patterns, and features of the digital contents in the content streams and stores such information into the database 331 to be used by the reordering module 123. Herein a length refers to the text length of an article or the duration of a video. A pattern refers to the media pattern such as text, music, image, audio, or video. A feature of a digital content is determined according to the pattern of the digital content. For example, the features of an article refer to keywords in the article. The features of music may be (but not limited to) the rhythm, tone, singer, and instruments thereof. The features of an image may be objects or profiles (for example, a house, a vehicle, a window, or a tire), people (for example, a man or a woman), or animals (for example, a cat or a dog) in the image. The features of a video may be (but not limited to) objects, actions in the video or the category, director, or actors of the video. Aforementioned features may be obtained through an existing feature extraction algorithm or tagged by their uploaders.

The reading behavior analysis module 322 generates a preference pattern of the user according to a clicking behaviour of the user in the reading behavior log regarding the digital contents and the features of the digital contents. This preference pattern represents the preference of the user to these digital contents. In the present embodiment, the preference pattern of the user includes features of those digital contents opened by the user in the reading behavior log and scores of these features. Herein a score is calculated by sorting the user's clicking behaviours into one or more categories and assigning a predetermined score to each clicking behaviour category. When the reading behavior analysis module 322 analyzes the reading behavior log of a specific user, every time when the user clicks at a digital content in the reading behavior log, the reading behavior analysis module 322 adds the features of the digital content to the preference pattern of the user and adds the score corresponding to the category of the clicking behaviour of the user regarding the digital content to the scores corresponding to the features of the digital content in the preference pattern of the user.

For example, reading behaviors of the user can be sorted into the four categories listed in following table 1, and these four behavior categories are corresponded to predetermined scores listed in table 1. All these reading behaviors come from the reading behavior log of the user.

TABLE 1
Reading Behaviours of User and Corresponding Scores

| Reading behavior | Score |
|---|---|
| Click | 1 |
| Press “like” | 2 |
| Cancel “like” | −1 |
| Share | 3 |

At the beginning, the preference pattern of the user is blank. If the user clicks at an article in the reading behavior log and the features of the article include {Menu, Tomato, Gravy, Pasta}, the reading behavior analysis module 322 adds {Menu, Tomato, Gravy, Pasta} to the preference pattern of the user and respectively adds 1 to the scores of the four features in the preference pattern of the user. Herein the preference pattern of the user is as shown in following table 2.

TABLE 2
Example of User's Preference Pattern

| Feature | Score |
|---|---|
| Menu | 1 |
| Tomato | 1 |
| Gravy | 1 |
| Pasta | 1 |

Next, if the user “likes” an article in the reading behavior log and the features of the article include {Baby, Solid food, Menu}, the reading behavior analysis module 322 adds {Baby, Solid food, Menu} to the preference pattern of the user and respectively adds 2 to the scores of the three features in the preference pattern of the user. Herein the preference pattern of the user is as shown in following table 3.

TABLE 3
Example of User's Preference Pattern

| Feature | Score |
|---|---|
| Menu | 3 |
| Tomato | 1 |
| Gravy | 1 |
| Pasta | 1 |
| Baby | 2 |
| Solid food | 2 |

After that, if the user shares a specific article in the reading behavior log and the features of the article include {Gravy, Tomato, Sausage, Stew}, the reading behavior analysis module 322 adds {Gravy, Tomato, Sausage, Stew} to the preference pattern of the user and respectively adds 3 to the scores of the four features in the preference pattern of the user. Herein the preference pattern of the user is as shown in following table 4.

TABLE 4
Example of User's Preference Pattern

| Feature | Score |
|---|---|
| Menu | 3 |
| Tomato | 4 |
| Gravy | 4 |
| Pasta | 1 |
| Baby | 2 |
| Solid food | 2 |
| Sausage | 3 |
| Stew | 3 |

It can be understood from this example that the features in the preference pattern of a user are a collection of features of digital contents viewed by the user in the reading behavior log. After the reading behavior analysis module 322 finishes analyzing the reading behavior log of a specific user through the method described above, a preference pattern of the user is obtained.

After the reading behavior analysis module 322 analyzes the reading behavior logs of one or more users, the user clustering module 323 obtains the preference patterns of these users from the reading behavior analysis module 322 and establishes a cluster tree according to an incremental hierarchical clustering algorithm and the preference patterns of these users. Besides, the user clustering module 323 adds the users respectively into clusters in the cluster tree and calculates common preference features of users in the clusters.

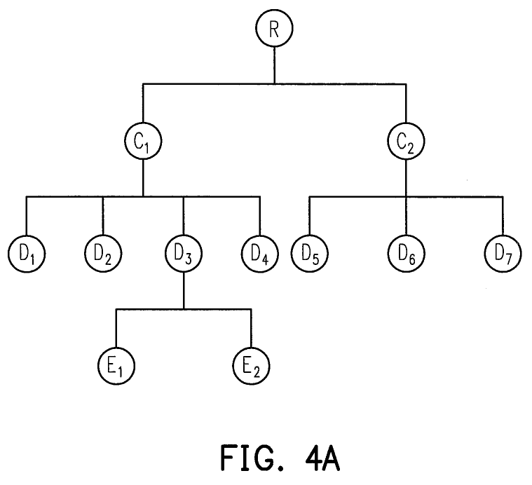

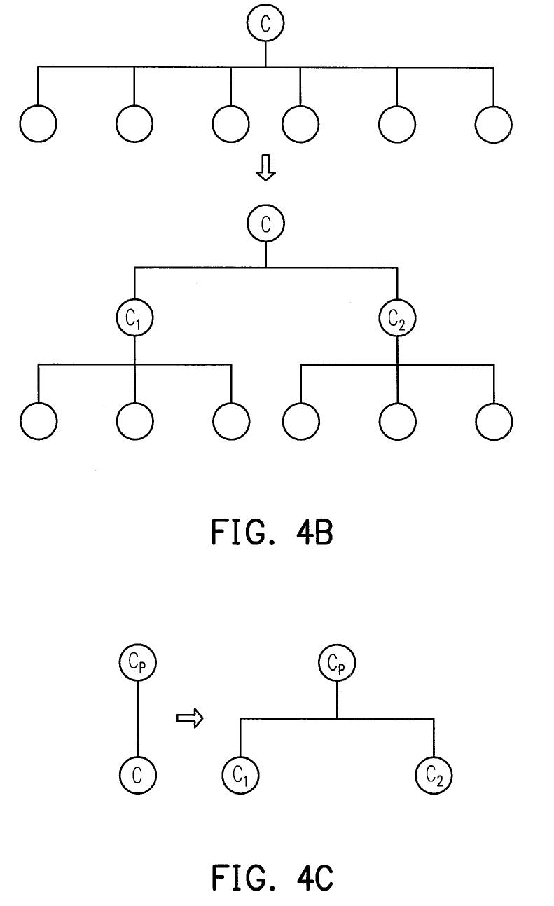

FIG. 4A illustrates an example of a cluster tree according to the present embodiment. Referring to FIG. 4A, the cluster tree has nodes R, C₁, C₂, D₁-D₇, E₁, and E₂. Each node is a cluster. Herein a cluster refers to a common interest group constituted by users with similar preferences. A cluster may further have child clusters (i.e., further divisions of the common interest group). For example, the cluster C₁ includes child clusters D₁-D₄, the cluster D₃ includes child clusters E₁ and E₂. The cluster C₁ is considered a parent cluster of the child clusters D₁-D₄, and the cluster D₃ is considered a parent cluster of the child clusters E₁ and E₂. A root cluster is the root node of a cluster tree, such as the root cluster R in FIG. 4A. The root cluster includes all users. An inner cluster is an inner node of a cluster tree, such as the inner clusters C₁, C₂, and D₃. Users in an inner cluster are a collection of users in the child clusters of the inner cluster. A leaf cluster is a leaf node of a cluster tree, such as the leaf clusters D₁-D₂, D₄-D₇, and E₁-E₂. Ultimately, each user belongs to a leaf cluster.

FIGS. 5A-5D illustrate an incremental hierarchical clustering algorithm executed by the user clustering module 323 in the present embodiment. However, the disclosure is not limited herein, and the purpose of establishing a cluster tree and clustering the users can also be achieved through other incremental hierarchical clustering algorithms.

The term “incremental” in the incremental hierarchical clustering algorithm means that the cluster tree needs not to be re-established every time after the reading behavior log is analyzed. Instead, the cluster tree is established when the reading behavior log is analyzed for the first time, and subsequently, the procedure illustrated in FIG. 5A is executed regarding each user every time after the reading behavior log is analyzed. In the procedure illustrated in FIG. 5A, the state of each user is checked. If a user already exists in the cluster tree, whether the user needs to move to another cluster is determined. If the user does not exist in the cluster tree, the user is added to a leaf cluster of the cluster tree according to the preference pattern of the user.

How the user clustering module 323 calculates a similarity has to be explained before the procedure illustrated in FIG. 5A is described. In the present embodiment, the user clustering module 323 can calculate three types of similarities, which are the similarity between two users, the similarity between a user and a cluster, and the similarity between two clusters.

The similarity between two users is calculated according to the preference patterns of the two users. There are many techniques for calculating the similarity or distance between two users, such as the Euclidean distance, the Mahalanobis distance, the Hamming distance, the Pearson correlation coefficient, the Spearman's rank correlation coefficient, and the cosine similarity. If the distance between two users is calculated, the similarity between the two users can be obtained by calculating the reciprocal of the distance. The Hamming distance calculation technique will be described below. However, the disclosure is not limited thereto, and other calculation techniques can be adopted in other embodiments.

Herein it is assumed that the similarity between a user A and a user B is to be calculated. First, features in the preference patterns of the users A and B are categorized into a plurality of sets according to at least one predetermined threshold. For example, features in the preference pattern of the user A are categorized into i+1 sets s_{A1}, s_{A2}, s_{A3}, . . . , and s_{A(i+1)} according to thresholds t₁, t₂, t₃, . . . , and tᵢ, wherein i is a positive integer, s_{A1} is a set of features in the preference pattern of the user A that have their scores smaller than t₁, s_{A2} is a set of features in the preference pattern of the user A that have their scores greater than or equal to t₁ and smaller than t₂, s_{A3} is a set of features in the preference pattern of the user A that have their scores greater than or equal to t₂ and smaller than t₃, . . . , and s_{A(i+1)} is a set of features in the preference pattern of the user A that have their scores greater than or equal to tᵢ. Similarly, features in the preference pattern of the user B are categorized into i+1 sets s_{B1}, s_{B2}, s_{B3}, . . . , and s_{B(i+1)} according to thresholds t₁, t₂, t₃, . . . , and tᵢ.

The similarity between users A and B is calculated by using following equation (1):

$$similarity = {\sum }_{j = 1}^{i + 1} {w}_{j} \times {Sim}_{j} \qquad ( 1 )$$

In foregoing equation (1), wⱼ represents predetermined weights corresponding to sets s_{Aj} and s_{Bj}, and Simⱼ is the similarity between sets s_{Aj} and s_{Bj}. If the total number of features in sets s_{Aj} and s_{Bj} is not zero, Simⱼ can be calculated by using following equation (2):

$${Sim}_{j} = \frac{2 \times count ( {s}_{Aj} ⋂ {s}_{Bj} )}{count ( {s}_{Aj} ) + count ( {s}_{Bj} )} \qquad ( 2 )$$

In foregoing equation (2), count( ) is the number of features in the set within the brackets. If the total number of features in the sets s_{Aj} and s_{Bj} is zero, Simⱼ is equal to 1.

In other embodiments of the disclosure, foregoing equation (1) for calculating similarity can be slightly changed as shown below:

$$similarity = {\sum }_{j = 0}^{i + 1} {w}_{j} \times {Sim}_{j} \qquad ( 3 )$$

w₀ and Sim₀ are brought into equation (3). Herein w₀ are predetermined weights corresponding to the sets s_{A0} and s_{B0}, Sim₀ is the similarity between the sets s_{A0} and s_{B0}, the set s_{A0} contains all the features in the preference pattern of the user A, and the set s_{B0} contains all the features in the preference pattern of the user B. The Sim₀ is calculated in the same way as the other Simⱼ.

The similarity between a user and a cluster is generated according to the preference pattern of the user and the preference pattern of at least one user in the cluster. For example, a preference pattern of the cluster is generated according to the preference patterns of the users in the cluster, wherein the preference pattern of the cluster contains common preference features of the users in the cluster. After that, the similarity between the user and the cluster is calculated by using the preference pattern of the user and the preference pattern of the cluster.

For example, if features in the preference pattern of each user U in a specific cluster C are categorized into i+1 sets s_{U1}, s_{U2}, s_{U3}, . . . , and s_{U(i+1)} according to predetermined thresholds t₁, t₂, t₃, . . . , and tᵢ through the technique described above, the preference pattern of the cluster C is then composed of the sets s_{C1}, s_{C2}, 5_{C3}, . . . , and s_{C(i+1)}. If a feature exists in the sets s_{U1} of users over a predetermined proportion in the cluster C, the feature is added to the set s_{C1} of the cluster C, if a feature exists in the sets s_{U2} of users over aforementioned predetermined proportion in the cluster C, the feature is added to the set s_{C2} of the cluster C, and so on. All features of every user in the cluster C are filtered through the technique described above to obtain the preference pattern of the cluster C.

Since the preference pattern of a cluster is in the same format as the preference pattern of a user, the similarity between the user and the cluster can be calculated by using foregoing equation (1) or (3).

However, the calculation of the similarity between a user and a cluster is not limited in the disclosure, and in other embodiments, the similarity between a user and a cluster may also be calculated through other techniques. Assuming that the similarity between a user A and a cluster Cis to be calculated, a user B is selected from the cluster C as a representative user of the cluster C. Then, the similarity between the users A and B is calculated as the similarity between the user A and the cluster C. The representative user B of the cluster C may be selected in different ways. For example, a user first added to the cluster C or a user having the preference pattern most similar to that of the cluster C may be selected as the representative user B. Or, a user may be randomly selected from the cluster C as the representative user B.

The similarity between two clusters can be calculated in two different ways. The first way is calculating the similarity between the preference patterns of the two clusters as the similarity between the two clusters. The second way is calculating the similarity between the representative users of the two clusters as the similarity between the two clusters.

The procedure illustrated in FIG. 5A will be described herein. The user clustering module 323 can execute the procedure in FIG. 5A for each of a plurality of users after the reading behavior analysis module 322 analyzes the reading behavior logs of these users and obtains the preference patterns of these users.

First, in step 502, whether a user exists in the cluster tree is checked. If the user already exists in the cluster tree, in step 504, whether the similarity between the user and the cluster to which the user originally belongs is greater than a predetermined hierarchical threshold T_{L} is determined. Herein the subscript L of the hierarchical threshold T_{L} represents the level of the cluster tree. The level of the root cluster R is 0, the level of the child clusters of the root cluster R is 1, and so on. In step 504, L is equal to the level of the cluster to which the user belongs. The hierarchical threshold T_{L} is an increasing function of the level L. For example, the hierarchical threshold T_{L} may be one, a variation, or a combination of an arithmetical progression, a geometric progression, and a progression increasing at an exponential rate.

If the similarity between the user and the original cluster is greater than the predetermined threshold, the user remains in the original cluster. Because the preference pattern of the user may change, the preference pattern of the cluster to which the user originally belongs has to be updated in step 506.

On the other hand, if the similarity between the user and the original cluster is not greater than the predetermined threshold, in step 508, the user is removed from the original cluster, in step 510, the preference pattern of the original cluster corresponding to the user is updated, and in step 512, the procedure illustrated in FIG. 5B is executed to find the cluster corresponding to the user in the cluster tree.

Back to step 502, if the user does not exist in the cluster tree, the procedure illustrated in FIG. 5B is directly executed in step 512 to find the cluster to which the user belongs in the cluster tree.

FIG. 5B illustrates step 512 in details, wherein a temporary variable C* is used for indicating a current cluster to which the user may join. First, in step 522, the variable C* is set as the root cluster R of the cluster tree. In step 524, whether the cluster tree has only the root cluster R is determined. If the cluster tree has only the root cluster R, the cluster tree is in its initial state and no user has ever joined the cluster tree. Accordingly, step 526 is executed to add a new child cluster C′ under the cluster C*, and step 528 is executed to set C* as the cluster C′. After that, step 542 is executed.

If it is determined in step 524 that the cluster tree further includes other clusters besides the root cluster R, step 530 is executed to check whether the cluster C* has any child cluster. If the cluster C* has no child cluster, step 542 is executed. If the cluster C* has child clusters, in step 532, the similarity between the user and each child cluster of the cluster C* is calculated. In step 534, whether following inequation is satisfied is determined.

$${max}_{{C}_{j} ∈ {C}^{*}} Sim ( {P}_{i} , {C}_{j} ) < {T}_{L + 1} \qquad ( 4 )$$

In foregoing inequation (4), max represents the maximum value, Pᵢ represents the user, Sim(Pᵢ, Cⱼ) represents the similarity between the user Pᵢ and the child cluster Cⱼ, T_{L+1} is the hierarchical threshold, and L is the level of the cluster C*. The inequation (4) means whether the highest similarity among the similarities between the user and the child clusters Cⱼ is smaller than the hierarchical threshold T_{L+1}. If the inequation (4) is not satisfied, in step 536, C* is set as the child cluster Cⱼ which has the highest similarity with the user. After that, step 530 is executed again. If the inequation (4) is satisfied, in step 538, a new child cluster C′ is added under the cluster C*, and in step 540, C* is set as the child cluster C′. After that, step 542 is executed.

In step 542, the user is added to the cluster C*, and the preference pattern of the cluster C* is updated, so that the cluster C* becomes the cluster to which the user belongs. In step 544, a representative user of the cluster C* is set. As described above, the representative user may be selected in many different ways. For example, the user first added to the cluster C* or the user having the preference pattern most similar to that of the cluster C* may be selected as the representative user of the cluster C*, or a user may be randomly selected from the cluster C* as the representative user of the cluster C*. If the first added user is selected as the representative user of the cluster C*, it is not needed to reselect the representative user when a new user is added to the cluster C*.

Next, in step 546, whether the parent cluster of the cluster C* satisfies an agglomerate condition is determined. Namely, whether the number of child clusters of the parent cluster of the cluster C* is greater than a predetermined agglomerate threshold T_{B} is determined. If the parent cluster of the cluster C* satisfies the agglomerate condition, in step 548, the agglomerate procedure illustrated in FIG. 5C is executed on the parent cluster of the cluster C*. Otherwise, if the parent cluster of the cluster C* does not satisfy the agglomerate condition, step 550 is directly executed. Next, in step 550, whether the cluster C* satisfies a split condition is determined. Namely, whether the number of users in the cluster C* is greater than a predetermined split threshold T_{F} is determined. If the cluster C* satisfies the split condition, the split procedure illustrated in FIG. 5D is executed on the cluster C* to split the cluster C* into two parts.

As described above, in the procedure illustrated in FIG. 5B, the similarity between the user and each cluster of the cluster tree is calculated by starting from the root cluster of the cluster tree, a downward path ending at a leaf cluster or a newly added leaf cluster is determined according to these similarities, and the last leaf cluster or the newly added leaf cluster eventually becomes the cluster to which the user belongs. Aforementioned agglomerate procedure and split procedure are executed to adjust the cluster tree, and which will be explained in detail below.

FIG. 5C is a flowchart of the agglomerate procedure. Referring to FIG. 4B, the agglomerate procedure is aimed at clusters having too many child clusters. For example, if the cluster C has too many child clusters, child clusters C₁ and C₂ are added under the cluster C and the original child clusters of the cluster C are respectively attached to the clusters C₁ and C₂.

Herein the agglomerate procedure will be described. First, in step 562, a cluster C is received. If the agglomerate procedure is executed in step 548 of FIG. 5B, the cluster C is the parent cluster of the cluster C* in step 548. If the agglomerate procedure is executed in step 596 of FIG. 5D, the cluster C is the cluster Cp in step 596.

Then, in step 564, all child clusters of the cluster C are removed, and these child clusters are added to a temporary list t. In step 566, two child clusters C₁ and C₂ are added under the cluster C. In step 568, a representative user A is selected among the representative users of all the child clusters in the temporary list t through any means. For example, the representative user A is randomly selected. Next, in step 570, the user A is set as the representative user of the cluster C₁, and the child cluster C_{A} accommodating the user A is removed from the temporary list t and attached to the cluster C₁ (i.e., the cluster C_{A} is made a child cluster of the cluster C₁).

Thereafter, in step 572, a representative user B who is the least similar to the representative user A is selected among the representative users of all the child clusters in the temporary list t. In step 574, the user B is set as the representative user of the cluster C₂, and the child cluster C_{B} accommodating the user B is removed from the temporary list t and attached to the cluster C₂ (i.e., the cluster C_{B} is made a child cluster of the cluster C₂).

Next, in step 576, regarding each remaining cluster C* in the temporary list t, the similarity between the cluster C* and the cluster C_{A} is compared with the similarity between the cluster C* and the cluster C_{B}. If the similarity between the cluster C* and the cluster C_{A} is higher, the cluster C* is attached to the cluster C₁ (i.e., the cluster C* is made a child cluster of the cluster C₁). If the similarity between the cluster C* and the cluster C_{B} is higher, the cluster C* is attached to the cluster C₂ (i.e., the cluster C* is made a child cluster of the cluster C₂). After that, in step 578, the preference patterns of the clusters C₁ and C₂ are updated.

FIG. 5D is a flowchart of the split procedure. Referring to FIG. 4C, the split procedure is aimed at clusters containing too many users. For example, if the cluster C has too many users, the cluster C is split into clusters C₁ and C₂.

Herein the split procedure will be described. First, in step 582, a cluster C is received. If the split procedure is executed in step 552 of FIG. 5B, the cluster C is the cluster C* in step 552.

Then, in step 584, the cluster C under the cluster Cp is removed. In step 586, child clusters C₁ and C₂ are added under the cluster Cp. In step 588, a user A is selected from the cluster C through any means, and the user A is added to the cluster C₁ as the representative user of the cluster C₁. The method for selecting the user A from the cluster C is not limited herein. For example, the user first added to the cluster C may be selected as the user A, or a user may be randomly selected from the cluster C as the user A. Thereafter, in step 590, a user B who is the least similar to the user A is found in the cluster C, and the user B is added to the cluster C₂ as the representative user of the cluster C₂.

Next, in step 592, regarding each remaining user X in the cluster C, the similarity between the user X and the user A is compared with the similarity between the user X and the user B. If the similarity between the user X and the user A is higher, the user X is added to the cluster C₁. Otherwise, if the similarity between the user X and the user B is higher, the user X is added to the cluster C₂. After that, the preference patterns of the clusters C₁ and C₂ are updated.

Next, in step 594, whether the parent cluster Cp of the cluster C satisfies an agglomerate condition is determined. Namely, whether the number of child clusters of the cluster Cp is greater than a predetermined agglomerate threshold T_{B} is determined. If the number of child clusters of the cluster Cp is greater than the predetermined agglomerate threshold T_{B}, in step 596, the agglomerate procedure illustrated in FIG. 5C is executed on the cluster Cp.

The preference pattern of a cluster includes features distributed in the preference patterns of the users in the cluster in proportions greater than or equal to a predetermined threshold and the distribution proportions of these features. For example, if a feature appears in the preference patterns of 83% users in the cluster, the distribution proportion of the feature is 0.83. The user clustering module 323 stores the preference pattern of each user, the cluster tree, and the preference pattern of each cluster in a database 332 to be used by the reordering module 123.

A cluster tree established through aforementioned incremental hierarchical clustering algorithm can be continuously used. When the reading behavior log of a specific user changes, the user clustering module 323 checks whether the similarity between the user and the cluster to which the user belongs is still greater than or equal to the predetermined hierarchical threshold T_{L}. If the similarity between the user and the cluster to which the user belongs is already smaller than the hierarchical threshold T_{L}, the user clustering module 323 deletes the user from the cluster, updates the preference pattern of the cluster, and adds the user into the cluster tree again. If the similarity between the user and the cluster to which the user belongs is still greater than or equal to the hierarchical threshold T_{L}, the user clustering module 323 simply updates the preference pattern of the cluster. Thereby, the frequency of re-establishing the cluster tree is reduced and accordingly the efficiency is increased.

The social relation analysis module 324 analyzes and captures interactive behaviors between a user and one or more friends of the user on social websites in the social behavior log. The preferences of the user's friends can be obtained through these interactive behaviors.

To be specific, the social relation analysis module 324 analyzes the social behavior log of a specific user and records whether a specific digital content is posted by the user's friend, recommended by the user's friends, and replied, redistributed, or quoted by the user's friends. However, the disclosure is not limited to these social behaviors. The social relation analysis module 324 may also analyze and record interactive behaviours (for example, press “like”, comment, or share) of the user regarding digital contents previously posted by the user's friends according to the social behavior log, calculate social relation scores between the user and the use's friends, and accordingly affect the popularity of the digital contents. The social relation analysis module 324 stores foregoing analysis result into a database 333 to be used by the reordering module 123.

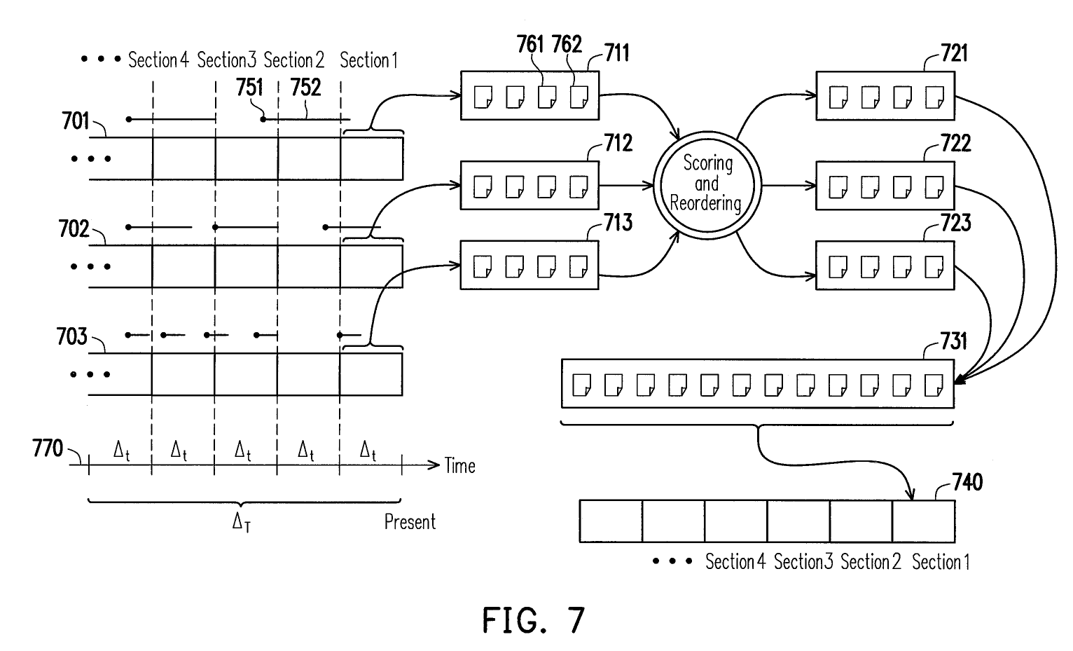

The reordering module 123 executes the procedure illustrated in FIG. 6 according to the analysis results stored in the databases 331-333, so as to aggregate a plurality of content streams from a plurality of content sources into an aggregated stream and reorder the digital contents in the aggregated stream. FIG. 7 is a diagram of the procedure in FIG. 6. Or, FIG. 7 illustrates an example of the procedure in FIG. 6. In FIG. 7, three content streams 701-703 are illustrated, and the block dots above the content streams 701-703 represent digital contents in the content streams 701-703 and the publication dates thereof. For example, the black dot 751 represents a digital content of the content stream 701 and the publication date of the digital content. The horizontal line to the right of each black dot represents the valid period of the digital content. For example, the horizontal line 752 represents the valid period of the digital content 751. The time axis 770 represents the time from past to present in the rightward direction.

Herein the procedure illustrated in FIG. 6 will be described. First, in step 620, the reordering module 123 partitions each of the content streams 701-703 into a plurality of sections. For example, the first sections of the content streams 701-703 are respectively the sections 711-713. In FIG. 7, Δ_{T} represents the duration of each content stream, and Δₜ represents the duration of each section. Each of the content streams 701-703 is composed of a plurality of sections, and the aggregated stream 740 output by the reordering module 123 is also composed of a plurality of sections. For each positive integer i, the i^{th} section of the aggregated stream 740 and the i^{th} section of each of the content streams 701-703 all have the same starting time and end time.

Each section includes one or more digital contents. For example, the first section 711 of the content stream 701 includes the digital contents 761 and 762. In the present embodiment, the section to which a digital content belongs can be determined through two different methods. Through the first method, each section includes digital contents in the content stream corresponding to the section that have their valid periods starting from the section, wherein the starting time of each aforementioned valid period is the publication date of the digital content. For example, the third section of the content stream 701 includes the digital content 751. Through the second method, each section includes digital contents in the content stream corresponding to the section that have their valid periods ending at the section. For example, the first section of the content stream 701 includes the digital content 751. Each valid period can be determined according to the update frequency of the content source or the length of the digital content. A longer valid period can be set regarding a content source of lower update frequency or a longer digital content, so as to allow a user to have longer time for reading the digital content.

Next, in step 640, the reordering module 123 determines the order of the digital contents in each of the sections according to a preference factor of the user regarding the digital contents in the section. To accomplish this step, the reordering module 123 calculates a total preference score corresponding to each digital content and sorts the digital contents in each section according to the total preference scores. A digital content with a higher total preference score is arranged closer to the beginning of the queue. A total preference score is calculated by using following equations:

TPS=Ω×(W_{Ω}+W_{L}P_{L}+W_{T}P_{T}+W_{R}P_{R}) (5)

W_{Ω}+W_{L}+W_{T}+W_{R}=1 (6)

In foregoing equations, TPS is the total preference score. Ω is a feature preference score of the user regarding the digital content, and which reflects digital contents with certain features are preferred by the user and the common interest group corresponding to the user. P_{L} is a length preference score of the user regarding the digital content, and which reflects digital contents of a certain length (for example, short sentence, short article, or long article) are preferred by the user. P_{T} is a type preference score of the user regarding the digital content, and which reflects digital contents of a certain media type (for example, text, music, image, or video) are preferred by the user. P_{R} is a social relation score of the user regarding the digital content, and which reflects whether interaction between the user and the user's friends on social websites is close and whether they prefer the same digital contents. W_{Ω}, W_{L}, W_{T}, and W_{R} are predetermined weights.

In the present embodiment, the total preference score TPS is calculated by using the scores Ω, P_{L}, P_{T}, and P_{R}. However, the disclosure is not limited thereto, and in other embodiments, the equations (5) and (6) can be simplified and the total preference score TPS can be calculated by using only one, two, or three of the scores Ω, P_{L}, P_{T}, and P_{R}. How the reordering module 123 calculates foregoing four scores will be explained below.

The feature preference score Ω may be equal to Ω₁, Ω₂, or Ω₁+Ω₂. Ω₁ and Ω₂ can be calculated by using following equations:

$$\begin{matrix}{Ω}_{1} = {\sum }_{{x}_{i} ∈ {Q}_{1}} log ( {x}_{i} \cdot p t + c ) & ( 7 ) \\ {Ω}_{2} = {\sum }_{{x}_{j} ∈ {Q}_{2}} {x}_{j} \cdot sup & ( 8 )\end{matrix}$$

In foregoing equation (7), Q₁ is an intersection of features of the digital content and features in the preference pattern of a user reading the digital content, xᵢ represents a feature in Q₁, xᵢ·pt is the score of the feature xᵢ in the preference pattern of the user, and c is a predetermined constant, such as 0, 1, or any other value.

In foregoing equation (8), Q₂ is an intersection of features of the digital content and features in the preference pattern of the cluster accommodating the user reading the digital content, xⱼ represents a feature in Q₂, and xⱼ.sup is the distribution proportion of the feature xⱼ in the preference pattern of the cluster.

To calculate the length preference score P_{L} and the type preference score P_{T}, digital contents can be sorted into a plurality of length categories (for example, short, medium, and long categories) and into a plurality of type categories (for example, short messages, texts, images, music, and videos). The length preference score P_{L} is the proportion of the length category of the digital content to all the digital contents in the reading behavior log of a user reading the digital content. The type preference score P_{T} is the proportion of the type category of the digital content to all the digital contents in the reading behavior log of the user reading the digital content.

The social relation score P_{R} is generated according to whether the digital content is recommended by the user's friends and the category of interactive behaviours of the user regarding digital contents previously posted by the user's friends. The social relation score P_{R} in the present embodiment is calculated by using following equation:

$${P}_{R} = {\sum }_{i ∈ F} {I}_{i} \times {RSC}_{i} \qquad ( 9 )$$

In foregoing equation (9), F is a set of friends of the user on social websites. The variable Iᵢ is generated according to interactions between the user and the user's friend i regarding the digital content, which will be explained in detail below. RSCᵢ is the relative social closeness between the user's friend i and the user, and the calculation thereof will be explained below.

First, interactive behaviours of the user regarding digital contents previously posted by the user's friends are sorted into a plurality of categories, and a score is set for each interactive behaviour category, as shown in following table 5:

TABLE 5
Example of Categories of User's Interactive Behaviours

| Interactive Behaviour Category | Score |
|---|---|
| Press “like” | 1 |
| Comment | 2 |
| Share | 3 |

Taking a friend B of the user as an example, the scores of all interactive behaviours of the user on a social website regarding digital contents previously posted by the friend B in the social behavior log of the user are added up to obtain social closeness SC_{B} between the user and the friend B. The social closeness between the user and any other friend can be calculated through the same way. Thereafter, the relative social closeness RSC_{B} between the user and the friend B is calculated by using following equation:

$${RSC}_{B} = \frac{{SC}_{B}}{{\sum }_{i ∈ F} {SC}_{i}} \qquad ( 10 )$$

In foregoing equation (10), F is a set of friends of the user, and SCᵢ is the social closeness between the friend i and the user.

In the present embodiment, the variable Iᵢ in foregoing equation (9) can be calculated through two different techniques. The first technique is applied when the digital content is from a non-social website, such as a news website or an e-magazine. In the first technique, the variable Iᵢ is calculated according to whether the digital content is recommend by the user's friend i. Herein the term “recommend” means that when the friend i reads the digital content on the viewer 130, the friend i presses “like” or any other similar action on the digital content. For example, if the digital content is recommended by the friend i, Iᵢ=1, otherwise Iᵢ=0.

In the second technique, the variable Iᵢ is calculated according to whether the digital content is posted or shared by the friend i on a social website and whether the digital content is replied by the friend i on the social website. For example, if the digital content is posted or shared by the friend i or receives any reply from the friend i, Iᵢ=1. If the digital content is not posted or shared by the friend i and does not receive any reply from the friend i, Iᵢ=0. Additionally, if the digital content is posted or shared by the friend i, the social closeness SCᵢ between the user and the friend i can be multiplied by a predetermined value, such as 2.

The reordering module 123 calculates the social relation score P_{R} according to foregoing equation (9). Or, the social relation analysis module 324 executes part of or all calculations of the equation (9) and stores the calculated result into a database 333 to be used by the reordering module 123.

Next, in step 660, the reordering module 123 composes an aggregated stream 740 by using the sections of the content streams 701-703. The aggregated stream 740 includes a plurality of sections, and regarding any positive integer i, the i^{th} section of the aggregated stream 740 is composed of the i^{th} section of each of the content streams 701-703. In the example illustrated in FIG. 7, the first sections 711-713 of the content streams 701-703 respectively become the sections 721-723 after step 640 is executed (in which the total preference score is calculated and the digital contents are sorted). Next, the reordering module 123 aggregates the sections 721-723 into the first section 731 of the aggregated stream 740. Other sections of the aggregated stream 740 are generated in the same way.

The reordering module 123 determines the order of digital contents from different content streams in the aggregated stream according to aggregated times of click of the user on the digital contents of each content stream in the reading behavior log. For example, assuming that in the reading behavior log of a specific, user, the aggregated times of click of the user on the digital contents of the content streams 701-703 are respectively C₁, C₂, and C₃, the click probabilities P₁, P₂, and P₃ of the content streams 701-703 are then calculated by using following equations:

P₁=C₁/(C₁+C₂+C₃) (11)

P₂=C₂/(C₁+C₂+C₃) (12)

P₃=C₃/(C₁+C₂+C₃) (13)

Next, another set of probabilities P₁′, P₂′, and P₃′ are calculated by using following equation:

Pₖ′=μ/n+(1−μ)×Pₖ (14)

In foregoing equation (14), n is the number of content streams. As to the content streams 701-703 in FIG. 7, n=3. k is an integer between 1 and n. According to foregoing equation (14), the probability Pₖ′ is the weighted average of the average probability 1/n and the click probability Pₖ, wherein the weights of the two probabilities are determined by a variable factor μ. The variable factor μ may be any real number between 0 and 1, such as 0.2. By bringing the variable factor μ in, the user is allowed to view recommended content sources that have not been viewed by the user before.

As to the i^{th} section (i is a positive integer) of the aggregated stream 740, the reordering module 123 randomly selects one of the content streams 701-703, wherein the probabilities of the content streams 701-703 being randomly selected are respectively P₁′, P₂′, and P₃′. After that, the reordering module 123 considers each section of the content streams 701-703 as a queue, selects the first digital content in the i^{th} section of the selected content stream (i.e., the digital content with the highest total preference score), and makes this digital content the first digital content in the i^{th} section of the aggregated stream 740. Next, the reordering module 123 selects one of the content streams 701-703 by using the same random number, selects the first digital content in the i^{th} section of the selected content stream, and makes this digital content the second digital content in the i^{th} section of the aggregated stream 740. This process goes on until the i^{th} sections of the content streams 701-703 all become empty queues. Accordingly, the digital contents in the i^{th} sections of the content streams 701-703 can all be merged into the i^{th} section of the aggregated stream 740.

The reordering module 123 generates each section of the aggregated stream 740 through the method described above and then outputs the aggregated stream 740 to the viewer 130 to be displayed. The viewer 130 displays the digital contents according to the order of the digital contents in the aggregated stream 740. Even though three content streams 701-703 are illustrated in FIG. 7, the disclosure is not limited thereto. In other embodiments, the digital content aggregator 120 can sort and aggregate any number of content streams.

The embodiments described above provide a digital content reordering method based on user preference and a digital content aggregator, in which digital contents are reordered based on personal preference of a user, preference of a common interest group to which the user belongs, and social relation of the user without sacrificing the freshness of the digital contents. Streamed digital contents are continuously generated with time, and the subjects, lengths, types, and posters thereof constantly change and are different from each other. In the digital content reordering method and the digital content aggregator provided by the embodiments described above, information from different sources is aggregated so that when every time a user reads the digital contents, the user can read most latest interesting subjects by flipping through the first few pages. Thereby, the user can obtain the latest and most interesting information in comfort.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A digital content reordering method, comprising:
aggregating at least one content stream into an aggregated stream, and determining an order of digital contents of the at least one content stream in the aggregated stream according to a time factor of the digital contents and a preference factor of a user regarding the digital contents.

2. The digital content reordering method according to claim 1, wherein the time factor comprises at least one of a publication date and a valid period of the digital contents, and the digital content reordering method further comprises:
partitioning each of the at least one content stream into a plurality of sections, wherein each of the sections comprises the digital contents in the content stream corresponding to the section that have the valid period starting from or ending at the section;
determining an order of the digital contents in at least one of the sections according to the preference factor of the user regarding the digital contents in the section; and
aggregating the sections of the at least one content stream into the aggregated stream, wherein the aggregated stream comprises a plurality of sections, the i^{th} section of the aggregated stream is formed by the i^{th} section of each of the at least one content stream, and i is a positive integer.

3. The digital content reordering method according to claim 2, wherein the i^{th} section of the aggregated stream has a same starting time and a same end time as the i^{th} section of each of the at least one content stream, and the order of digital contents from different content streams in the aggregated stream is determined according to aggregated times of click of the user on the digital contents of the content streams.

4. The digital content reordering method according to claim 2, wherein the preference factor comprises at least one of a preference and a social relation of the user regarding the digital contents, and the step of determining the order of the digital contents in at least one of the sections comprises:
calculating a total preference score of a first digital content in the section; and
determining an order of the first digital content in the section according to the total preference score, wherein the total preference score is generated according to at least one of a feature preference score, a length preference score, a type preference score, and a social relation score of the user regarding the first digital content, wherein the feature preference score is generated according to features of the first digital content and a preference pattern of the user, the preference pattern of the user is generated according to clicking behaviors of the user on the digital contents of the at least one content stream and features of the digital contents of the at least one content stream, the digital contents of the at least one content stream respectively belong to a plurality of length categories and a plurality of type categories, the length preference score is generated according to a proportion of the length category corresponding to the first digital content to the length categories of all the digital contents, the type preference score is generated according to a proportion of the type category corresponding to the first digital content to the type categories of all the digital contents, and the social relation score is generated according to interactive behaviours between the user and at least one friend of the user on a social website regarding the first digital content.

5. The digital content reordering method according to claim 4, wherein the preference pattern of the user comprises features of digital contents clicked by the user and scores of the features, the clicking behaviours of the user belong to at least one category, each of the at least one category of the clicking behaviours is corresponding to a score, and the digital content reordering method further comprises:
when the user clicks at a second digital content, adding at least one feature of the second digital content into the preference pattern of the user, and adding the score of the category of the clicking behaviour of the user regarding the second digital content to the score of the at least one feature of the second digital content in the preference pattern of the user.

6. The digital content reordering method according to claim 5 further comprising:
determining a first cluster to which the user belongs in a cluster tree according to an incremental hierarchical clustering algorithm; and
updating a preference pattern of the first cluster, wherein the preference pattern of the first cluster comprises features in the preference patterns of the users in the first cluster that have distribution proportions greater than or equal to a first threshold and the distribution proportions of the features.

7. The digital content reordering method according to claim 6, wherein the feature preference score is equal to a first value, a second value, or a sum of the first value and the second value, the first value is generated according to the score of at least one feature in an intersection between the features of the first digital content and the features in the preference pattern of the user, and the second value is generated according to the distribution proportion of at least one feature in an intersection between the features of the first digital content and the features in the preference pattern of the first cluster.

8. The digital content reordering method according to claim 6, wherein the step of determining the first cluster according to the incremental hierarchical clustering algorithm comprises:
when the user already exists in the cluster tree and a similarity between the user and a second cluster to which the user originally belongs is greater than a second threshold, the first cluster being the second cluster;
when the user already exists in the cluster tree and the similarity between the user and the second cluster is smaller than or equal to the second threshold, removing the user from the second cluster, updating a preference pattern of the second cluster, and searching for the first cluster in the cluster tree; and
when the user does not exist in the cluster tree, searching for the first cluster in the cluster tree, wherein the step of searching for the first cluster in the cluster tree comprises:
in the cluster tree, calculating a similarity between the user and each cluster in the cluster tree by starting from a root cluster of the cluster tree, and determining a downward path ending at a first leaf cluster or a newly added second leaf cluster according to the similarities, wherein the first cluster is the first leaf cluster or the second leaf cluster, and the similarity between the user and any cluster in the cluster tree is calculated according to the preference pattern of the user and the preference pattern of at least one user in the cluster.

9. The digital content reordering method according to claim 4, wherein the social relation score is generated according to whether the first digital content is recommended by the at least one friend and a category of interactive behaviours of the user regarding digital contents previously posted by the at least one friend.

10. The digital content reordering method according to claim 4, wherein the social relation score is generated according to whether the first digital content is posted or shared by the at least one friend, whether the first digital content is replied by the at least one friend, and a category of interactive behaviours of the user regarding digital contents previously posted by the at least one friend.

11. A digital content aggregator, comprising:
a preference analysis module, analyzing a preference factor of a user regarding digital contents of at least one content stream according to a reading behavior log and/or a social behavior log; and
a reordering module, aggegating the at least one content stream into an aggregated stream, and determining an order of the digital contents in the aggregated stream according to a time factor of the digital contents and the preference factor.

12. The digital content aggregator according to claim 11, wherein the time factor comprises at least one of a publication date and a valid period of the digital contents, the reordering module partitions each of the at least one content stream into a plurality of sections, wherein each of the sections comprises the digital contents in the content stream corresponding to the section that have the valid period starting from or ending at the section, the reordering module determines an order of the digital contents in at least one of the sections according to the preference factor of the user regarding the digital contents in the section, the reordering module aggregates the sections of the at least one content stream into the aggregated stream, wherein the aggregated stream comprises a plurality of sections, the i^{th} section of the aggregated stream is formed by the i^{th} section of each of the at least one content stream, and i is a positive integer.

13. The digital content aggregator according to claim 12, wherein the i^{th} section of the aggregated stream has a same starting time and a same end time as the i^{th} section of each of the at least one content stream, and the reordering module determines the order of digital contents from different content streams in the aggregated stream according to aggregated times of click of the user on the digital contents of the content streams.

14. The digital content aggregator according to claim 12, wherein the preference factor comprises at least one of a preference and a social relation of the user regarding the digital contents, and the preference analysis module comprises:
a digital content analysis module, analyzing and capturing publication dates, lengths, types, and features of the digital contents of the at least one content stream;
a reading behavior analysis module, generating a preference pattern of the user according to clicking behaviours of the user regarding the digital contents of the at least one content stream in the reading behavior log and the features of the digital contents of the at least one content stream;
a social relation analysis module, analyzing and capturing interactive behaviours between the user and at least one friend of the user on a social website in the social behavior log, wherein
the reordering module calculates a total preference score of a first digital content in the section and determines an order of the first digital content in the section according to the total preference score, wherein the total preference score is generated according to at least one of a feature preference score, a length preference score, a type preference score, and a social relation score of the user regarding the first digital content;
the reordering module generates the feature preference score according to features of the first digital content and the preference pattern of the user
the digital contents of the at least one content stream respectively belong to a plurality of length categories and a plurality of type categories, and the reordering module generates the length preference score according to a proportion of the length category corresponding to the first digital content to the length categories of all the digital contents and generates the type preference score according to a proportion of the type category corresponding to the first digital content to the type categories of all the digital contents;
the reordering module generates the social relation score according to the interactive behaviours of the user.

15. The digital content aggregator according to claim 14, wherein the preference pattern of the user comprises features of digital contents clicked by the user in the reading behavior log and scores of the features, the clicking behaviours of the user belong to at least one category, and each of the at least one category of the clicking behaviours is corresponding to a score, when the user clicks at a second digital content in the reading behavior log, the reading behavior analysis module adds at least one feature of the second digital content into the preference pattern of the user and adds the score of the category of the clicking behaviour of the user regarding the second digital content to the score of the at least one feature of the second digital content in the preference pattern of the user.

16. The digital content aggregator according to claim 15, wherein the preference analysis module further comprises:
a user clustering module, determining a first cluster to which the user belongs in a cluster tree according to an incremental hierarchical clustering algorithm, and updating a preference pattern of the first cluster, wherein the preference pattern of the first cluster comprises features in the preference patterns of users in the first cluster that have distribution proportions greater than or equal to a first threshold and the distribution proportions of the features.

17. The digital content aggregator according to claim 16, wherein the feature preference score is equal to a first value, a second value, or a sum of the first value and the second value, the first value is generated according to the score of at least one feature in an intersection between the features of the first digital content and the features in the preference pattern of the user, and the second value is generated according to the distribution proportion of at least one feature in an intersection between the features of the first digital content and the features in the preference pattern of the first cluster.

18. The digital content aggregator according to claim 16, wherein when the user already exists in the cluster tree and a similarity between the user and a second cluster to which the user originally belongs is greater than a second threshold, the first cluster is the second cluster; when the user already exists in the cluster tree and the similarity between the user and the second cluster is smaller than or equal to the second threshold, the user clustering module removes the user from the second cluster, updates a preference pattern of the second cluster, and searches for the first cluster in the cluster tree; and when the user does not exist in the cluster tree, the user clustering module searches for the first cluster in the cluster tree, wherein to search for the first cluster in the cluster tree, the user clustering module calculates a similarity between the user and each cluster in the cluster tree by starting from a root cluster of the cluster tree and determines a downward path ending at a first leaf cluster or a newly added second leaf cluster according to the similarities, wherein the first cluster is the first leaf cluster or the second leaf cluster, and the similarity between the user and any cluster in the cluster tree is calculated according to the preference pattern of the user and the preference pattern of at least one user in the cluster.

19. The digital content aggregator according to claim 14, wherein the social relation analysis module analyzes and records whether the first digital content is recommended by the at least one friend and interactive behaviours of the user regarding digital contents previously posted by the at least one friend according to the social behavior log, and the social relation score is generated according to whether the first digital content is recommended by the at least one friend and a category of the interactive behaviours of the user regarding the digital contents previously posted by the at least one friend.

20. The digital content aggregator according to claim 14, wherein the social relation analysis module analyzes and records whether the first digital content is posted by the at least one friend, whether the first digital content is replied by the at least one friend, and interactive behaviours of the user regarding digital contents previously posted by the at least one friend according to the social behavior log, and the social relation score is generated according to whether the first digital content is posted or shared by the at least one friend, whether the first digital content is replied by the at least one friend, and a category of the interactive behaviours of the user regarding the digital contents previously posted by the at least one friend.
